(19) United States
(12) Patent Application Publication
(10) Pub. No.: US 2010/0230967 A1
(43) Pub. Date: Sep. 16, 2010

(54) WIND POWER GENERATOR

(76) Inventor: Hyun-Kang Heo, Gyeonggi-do (KR)

Correspondence Address: JORDAN AND HAMBURG LLP, 122 EAST 42ND STREET, SUITE 4000, NEW YORK, NY, 10168, US

(21) Appl. No.: 12/681,850

(22) PCT Filed: Sep. 5, 2008
(86) PCT No.: PCT/KR08/05251

§ 371 Date: Jun. 7, 2010

(30) Foreign Application Priority Data
May 2, 2008 (KR) 10-2008-0041130

(51) Int. Cl. F03D 9/00; F03D 7/00; F03D 11/00

(52) U.S. Cl. 290/44; 290/55

(57) ABSTRACT

A wind power generator in which a rotating force of front and rear blades, which rotate in opposite directions to each other against the wind, enables a permanent magnet and a coil body to rotate in opposite directions so as to provide high efficiency of power generation, wherein at a low wind speed, according to the wind direction, the wind power generator freely rotates towards the wind so as to face the wind, at a middle wind speed the wind power generator is forced to rotate toward the wind so as to face the wind using power of a driving motor, and at a high wind speed the wind power generator is forced to rotate perpendicular to the wind using power of the driving motor so as to prevent the front and rear blades from breaking in a strong wind.

### BACKGROUND OF THE INVENTION

The present invention relates, in general, to a wind power generator, and more particularly, to a wind power generator in which a rotating force of front and rear blades, which rotate in opposite directions against the wind, enables a permanent magnet and a coil body to rotate in the opposite direction so as to provide a high efficiency of power generation. In operation at a low wind speed, the wind power generator freely rotates in the wind direction so as to face the wind. At an intermediate wind speed, the wind power generator is forced to rotate toward the wind so as to face it, using power of a driving motor. Finally, at a high wind speed, the wind power generator is forced to rotate perpendicular to the wind using power of the driving motor, so as to prevent the front and rear blades from being broken by the strong wind.

The applicant previously proposed a wind power generator in which a rotating force of front and rear blades rotating in opposite directions, enables a permanent magnet and a coil body to rotate in opposite directions so as to provide a high efficiency of power generation.

However, while such a wind power generator having two blades rotating in opposite directions to each other operates even at a low wind speed and generates more electricity compared to a wind power generator having a single blade, at a high wind speed, the blades thereof rotate very fast and thus are likely to break.

Further, at a region where the wind shifts quickly in all directions without blowing in one single direction, it is very important for the wind power generator to have a function of automatic yawing such that the wind power generator automatically rotates towards the eye of the wind according to the wind direction.

However, a conventional wind power generator has a poor automatic yawing function, so that it is difficult to quickly rotate in the direction of the wind thereby inducing failure, causing a reduction in the lifecycle due to the overstrained rotating operation, making it difficult to manage and repair the generator and reducing the generating efficiency as well.

### SUMMARY OF THE INVENTION

Accordingly, the present invention has been made in an effort to solve the problems occurring in the related art, and an object of the present invention is to provide a wind power generator which, according to the wind direction, at a low wind speed freely rotates towards the wind so as to face it, at a middle wind speed is forced to rotate towards the wind so as to face it using power of a driving motor, and at a high wind speed is forced to rotate perpendicular to the wind using power of the driving motor so as to prevent front and rear blades from breaking due to the strong wind.

In order to achieve the above object, according to one aspect of the present invention, there is provided a wind power generator including front and rear blades rotating in opposite directions to each other and against the wind, a permanent magnet, and a coil body, wherein a rotating force of the front and rear blades enables the permanent magnet and the coil body to rotate in opposite directions so as to provide a high efficiency of power generation, wherein further (in accordance with the wind direction) at a low wind speed (12 m/s or less) the wind power generator freely rotates towards the wind on the slant so as to face it at an angle, at a middle wind speed (12 m/s or more) the generator is forced to rotate towards the wind so as to face it using power of a driving motor, and at a high wind speed (18 m/s or more) the generator is forced to rotate perpendicular to the wind using power of the driving motor so as to prevent the front and rear blades from breaking by the strong wind.

According to the present invention, the wind power generator provides the effects that it takes a position quickly both facing the shifting wind according to the wind direction so as to improve the efficiency of power generation, and facing a strong wind perpendicularly so as to prevent the front and rear blades and the body from breaking or being put out of order due to the strong wind.

### BRIEF DESCRIPTION OF THE DRAWINGS

FIG. 1 is a cross-sectional view illustrating a wind power generator according to the present invention;

FIGS. 2 to 4 are enlarged views illustrating the internal construction of the wind power generator of the present invention;

FIG. 5 is a block diagram illustrating control means of the wind power generator;

FIG. 6 is a flow chart illustrating a control procedure for the wind power generator of the invention;

FIG. 7 is a view illustrating the operating state of the wind power generator of the invention;

FIG. 8 is a perspective view illustrating a wind power generator according to another embodiment of the invention;

FIG. 9 is a cross-sectional view illustrating the wind power generator shown in FIG. 8; and

FIG. 10 is a cross-sectional plan view illustrating the coupling state between a post and a pivot support in the wind power generator according to the embodiment.

### DESCRIPTION OF SIGNS OF MAJOR PARTS IN THE DRAWINGS

### Detailed Description of the Invention

The present invention is directed to provide a wind power generator including front and rear blades, which are axially connected to front and rear ends, respectively, of a main body, which is installed on a tower post having a certain height, so as to rotate in the wind in directions opposite to each other, a permanent magnet rotating using a rotating force transmitted from the front blade, and a coil body rotating in the opposite direction of the permanent magnet using a rotating force transmitted from the rear blade, the permanent magnet and the coil body being installed in the main body,

wherein the front blade is connected to a front hub, which is coupled to a leading end of a front shaft axially connected to the front of the main body, a spider is fastened to the middle of the front shaft, and the permanent magnet is installed on an outer diameter of the spider, and

wherein a rotating body is coupled at its inner side with the front shaft by means of a bearing so that it receives the permanent magnet, the coil body is installed on the outer side of the rotating body opposite the permanent magnet, and the rear blade is connected to a rear hub coupled to an end of a rear shaft, which is installed to an inner rear end of the main body such that it is connected to an end of the inner side of the rotating body with its end exposed out of a rear end of the main body.

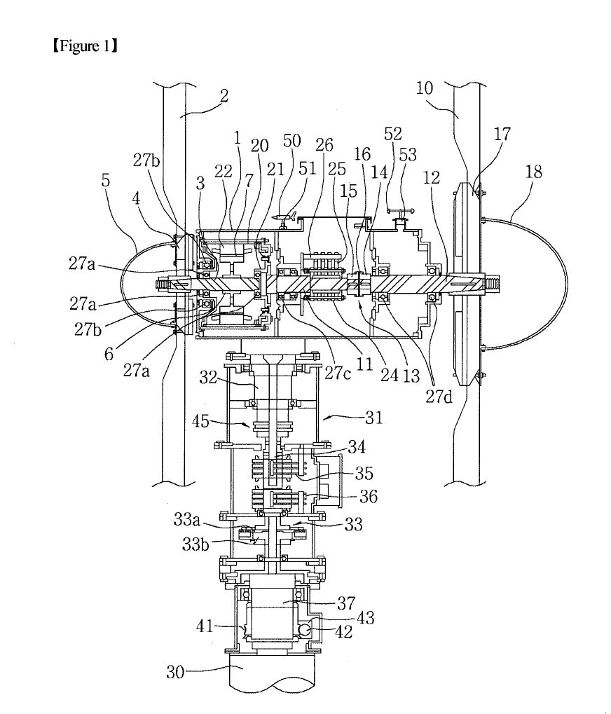

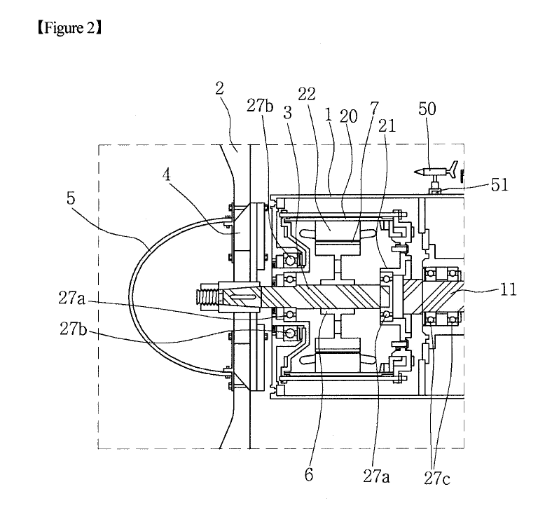

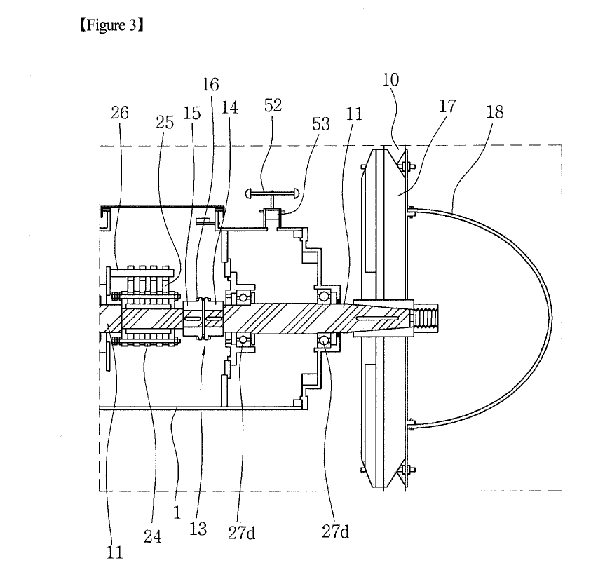

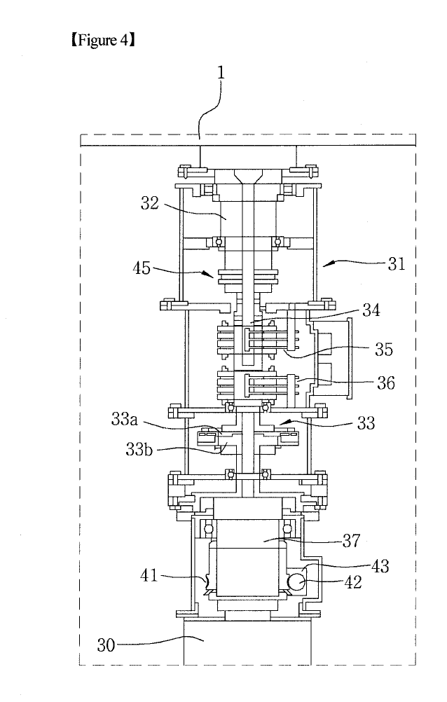

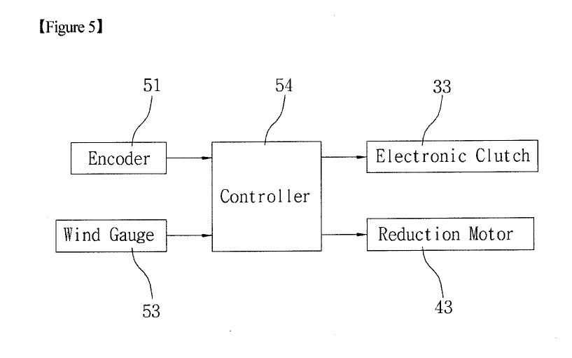

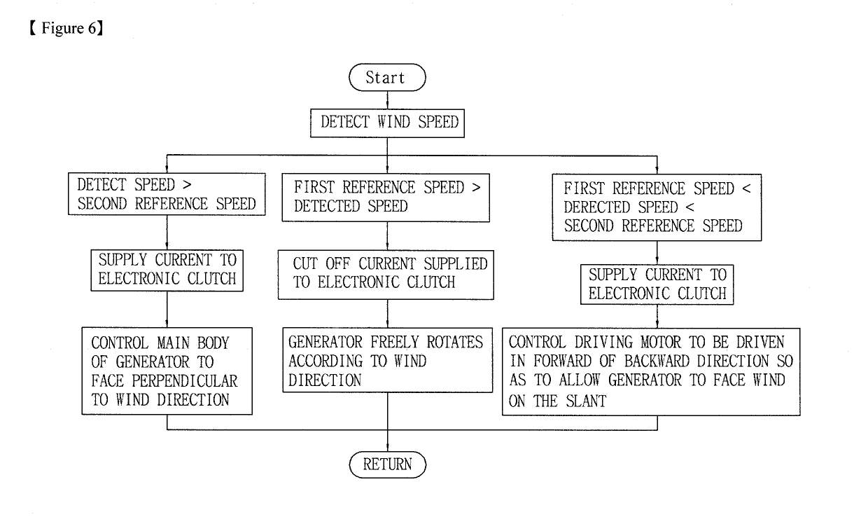

Description will now be made in greater detail of a preferred embodiment of the invention with reference to FIGS. 1 to 7.

A reference numeral 1 denotes a main body of a wind power generator.

The wind power generator includes front and rear blades 2 and 10, which are axially connected respectively to front and rear ends of the main body 1 so as to rotate under the force of the wind in opposite directions. In the main body 1 are provided permanent magnets 7 rotating using a rotating force transmitted from the front blade 2, and a coil body 22 rotating in an opposite direction of the permanent magnet 7 using a rotating force transmitted from the rear blade 10. The main body 1 is installed on a tower post 30 having a certain height.

A front hub 4 is coupled to a leading end of a front shaft 3 axially connected to the front of the main body 1. The front blade 2 is connected to the front hub 4 by means of a plurality of bolts. A front hub cap 5 is coupled to the front of the front hub 4 so as to protect the front shaft 3 from wind and rain or external shocks. A spider 6 is fastened to the middle of the front shaft 3, and the permanent magnets 7 are fixedly installed on an outer diameter of the spider 6 at certain intervals.

Since the permanent magnets 7 are installed in such a way as to be connected to the front shaft 3, to which the front blade 2 is axially connected, they rotate in the same direction as the front blade 2.

In the meantime, a rotating body 20 is coupled at its inner side 21 with the front shaft 3 by means of a bearing 27a such that it rotates independently from the front shaft 3. The rotating body is installed in the main body 1 so that it receives the permanent magnets 7. The coil body 22 is installed on an outer diameter of the rotating body 20 opposite the permanent magnets 7, such that it rotates in the opposite direction of the permanent magnets 7 by a rotating force of the rear blade 10.

A rear shaft is installed to an inner rear end of the main body 1 such that it is connected to an end of the inner side 21 of the rotating body 20 with its end exposed out of a rear end of the main body 1. The rear blade 10 is connected to a rear hub 17, which is coupled to an end of the rear shaft, and a rear hub cap 18 is coupled to the rear hub 17 so as to protect the rear shaft.

Here, the rear shaft consists of a first rear shaft section 11 connected to the end of the inner side 21 of the rotating body 20, and a second rear shaft section 12 connected with the first rear shaft section 11 by means of a chain coupling 13 while the rear hub 17 is coupled to the end of the second rear shaft section.

The chain coupling 13 has a first sprocket 14 connected to an end of the first rear shaft section 11, a second sprocket 15 connected to an end of the second rear shaft section 12, and a double chain 16 connecting the first and second sprockets 14 and 15 together, thereby connecting the first and second rear shaft sections 11 and 12 with each other. Thus, a rotating force of the rear blade 10 is transmitted to the coil body 22 via the rear hub 17, the second rear shaft section 12, the first rear shaft section 11, and the rotating body 20 in order, so that the coil body 22 rotates in the opposite direction of the permanent magnets 7.

To the first rear shaft section 11, a slip ring 24, a brush 25, and a brush holder 26 are connected so as to transmit electricity which is induced in the coil body 22. Electricity transmitted via the brush 25 is supplied to a charger after being rectified by a rectifier. The construction of the slip ring, the brush, and the brush holder is a known construction, so that detailed description thereof will be omitted.

Unexplained reference numerals 27a, 27b, 27c, and 27d denote a bearing.

Meanwhile, a housing 31 is vertically provided between the main body 1 and the tower post 30 installed on the ground, and has therein a rotating device for rotating the main body 1.

The rotating device includes a first rotating support-axis 32, which is axially installed as a free-rotating means of the main body 1, a slip ring-fixing axis 34 connected to a lower portion of the first rotating support-axis 32 by means of a coupling 45, first and second slip rings 35 and 36 axially connected to the slip ring-fixing axis 34 as power supply means, a second rotating support-axis 37 functioning as a transmitting means of a forced rotating driving force, an electronic clutch 33 axially connected between the slip ring-fixing axis 34 and the second rotating support-axis 37 functioning as transmitting and controlling means of the forced rotating driving force, a worm 41 and a worm gear 42 axially installed on the second rotating support-axis 37, and a reduction motor 43 axially installed on the worm gear 42.

The electronic clutch 33 consists of an electromagnet 33b, which is selectively magnetized according to supplied electricity, and a disk 33a provided on the electromagnet 33b. The disk 33a is connected with the slip ring-fixing axis 34 thereabove, and the electromagnet 33b is connected with the second rotating support-axis 37 thereunder.

Thus, if an electric current is not supplied to the electromagnet 33b, the first rotating support-axis 32 can rotate freely because the disk 33a and the electromagnet 33b are in a separated state. Further, if an electric current is supplied to the electromagnet 33b, the disk 33a comes into contact with the electromagnet 33b, so that the first rotating support-axis 32 thus rotates by a forced rotating force provided by the reduction motor 43.

Meanwhile, the wind power generator of the invention further includes control means for automatically yawing the wind power generator according to wind direction and wind speed.

The control means includes an encoder 51 outputting information on wind direction corresponding to a rotated angle of a wind indicator 50 which is installed on the main body 1, a wind gauge 53 detecting and outputting a wind speed using a rotating speed of a wind speed-detecting vane 52 which is installed on the main body 1, and a controller 54 which selectively supplies an electric current to the electronic clutch 33 according to the wind speed detected by the wind gauge 53 and drives the reduction motor 43 in a forward or backward direction according to information on wind direction supplied from the encoder 51, so as to control the main body 1 to face the wind on the slant.

The wind indicator 50 is installed on the main body 1 so as to rotate according to the wind direction, and the encoder 51 is installed so as to be connected with an axis of the wind indicator 50, so that information on the wind direction, which corresponds to a rotated angle of the wind indicator 50, is supplied to the controller 54 in a pulse form.

Further, the wind speed-detecting vane 52 is installed on the main body 1 so as to rotate according to the wind speed, and the wind gauge 53 is installed on the main body 1 so as to be connected with an axis of the wind speed-detecting vane 52, so that the wind gauge 53 outputs information on the wind speed corresponding to the rotating speed of the wind speed-detecting vane 52 to the controller 54.

Here, the operation of the controller 54 will be described furthermore in detail.

When the detected wind speed belongs to a first predetermined reference wind speed (12 m/s) or less, the controller 54 cuts off an electric current supplied to the electromagnet 33b of the electronic clutch 33 so that the main body 1 freely rotates according to the wind direction.

If an electric current is not supplied to the electromagnet 33b, because the first rotating support-axis 32 and the slip ring-fixing axis 34 are maintained separated off relative to the electromagnet 33b and the disk 33a above the electronic clutch 33, at a low wind speed of 12 m/s or less, the main body 1 of the wind power generator correspondingly rotates to face the wind from a reference point of the disk 33a of the electronic clutch 33 to thereby maximize to the utmost the efficiency of power generation using wind power.

Meanwhile, when the detected wind speed belongs to a range between the first predetermined referenced wind speed (12 m/s) and a second predetermined reference wind speed (18 m/s), the controller 54 supplies an electric current to the electronic clutch 33 so as to connect the slip ring-fixing axis 34 and the second rotating support-axis 37 with each other. Then, the controller 54 drives a driving motor 38 in a forward or backward direction according to information on the wind direction from the encoder 51, so as to forcibly rotate the main body 1 to face the wind on the slant.

That is, when the wind having the intermediate wind speed of 12 m/s or more begins to blow, an electric signal of the wind gauge and the wind indicator is input into the controller 54, which then emits an output signal based on input information so as to operate the reduction motor 43 and the electronic clutch 33. Then, the electromagnet 33b of the electronic clutch 33 is instantaneously magnetized, so that the disk 33a is coupled with the electromagnet 33b and a rotating driving force of the reduction motor 43, which is rotated and driven by a given instruction angle, is transferred to the main body 1 of the wind power generator as well via the worm gear 42, the worm 41, the second rotating support-axis 37, the electronic clutch 33, the slip ring-fixing axis 34, the coupling 45, and the first rotating support-axis 32, so that the main body 1 correspondingly rotates according to the wind direction.

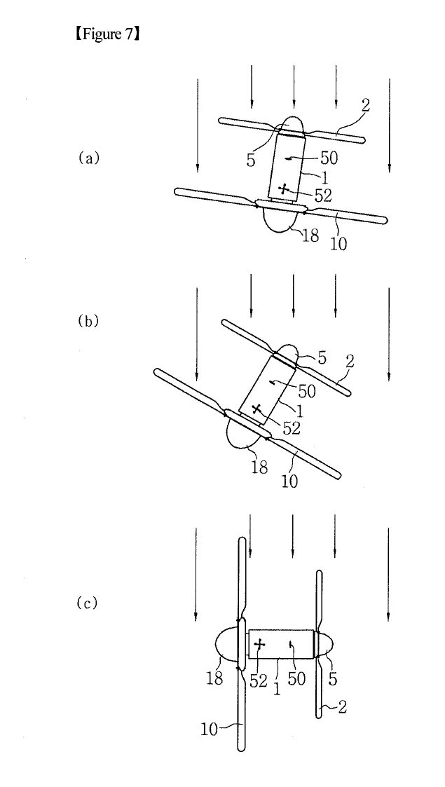

FIG. 7a illustrates the wind power generator when the wind speed belongs to a range of 12 m/s to 15 m/s, so that the wind power generator is rotated diagonally slightly aslant to the wind direction under the control of the controller 54, and FIG. 7b illustrates the wind power generator when the wind speed belongs to a range of 15 m/s to 18 m/s, and the wind power generator is rotated further diagonally aslant to the wind direction under the control of the controller 54.

The reason why at the intermediate wind the wind power generator faces the wind on the slant is that, since the wind power generator of the invention is a highly efficient generator in which the permanent magnet and the coil body rotate in directions opposite to each other so as to generate electricity, if the front and rear blades are rotated very fast, the coil body can be burn out by overload.

In the meantime, when the detected wind speed belongs to the second predetermined reference speed of 18 m/s or more, the controller 54 controls the electronic clutch 33 and the reduction motor 43 to rotate the main body 1 perpendicular to the wind direction as illustrated in FIG. 7c so that the front and rear blades 2 and 10 are not driven under the strong wind, thereby preventing the front and rear blades 2 and 10 from breaking under the strong wind.

The first and second reference wind speeds, which are references used for the operation of the controller 54, are gathered from experimental data. In operation, below the first reference wind speed, the front and rear blades 2 and 10 face into the wind and the main body 1 freely rotates to track the wind slowly. Between the first reference wind speed and the second reference wind speed, the front and rear blades 2 and 10 rotate at a relatively rapid speed so that the main body 1 rotates so fast as to possibly cause the internal parts thereof to break owing to friction. Thus, in this case, the controller controls the main body to rotate slowly using a rotating force of the reduction motor 43. At a strong wind above the second reference wind speed, the front and rear blades 2 and 10 rotate at an excessive speed and thus possibly break, so that the main body is controlled to rotate perpendicular to the wind as illustrated in FIG. 7.

Reference numerals 40a, 40b, 40c, and 40d denote bearings to support axes.

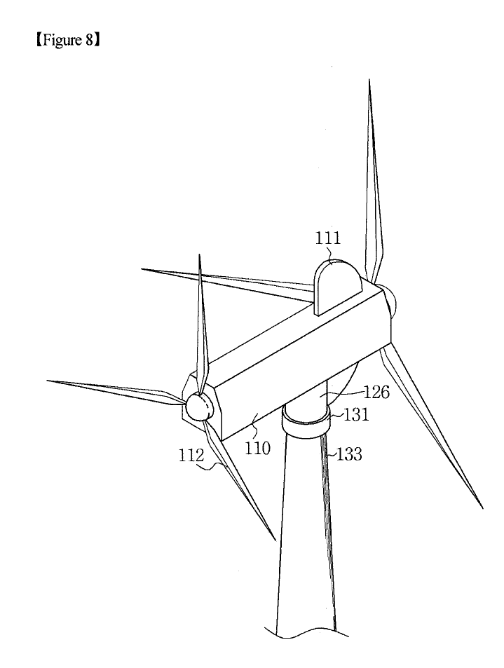

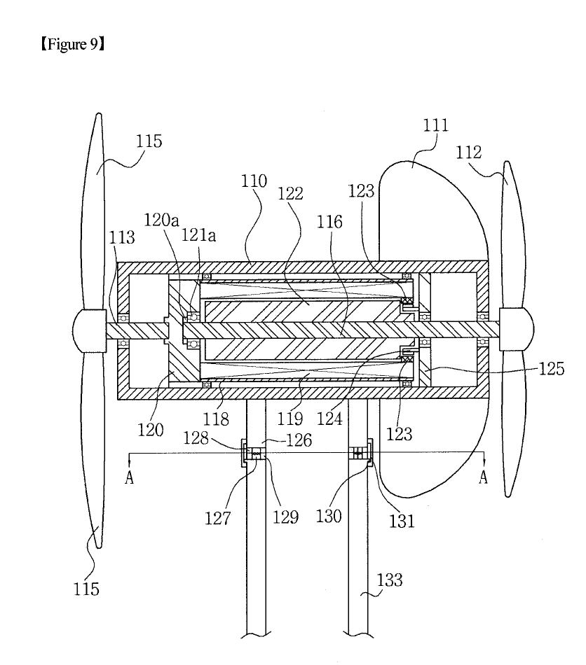

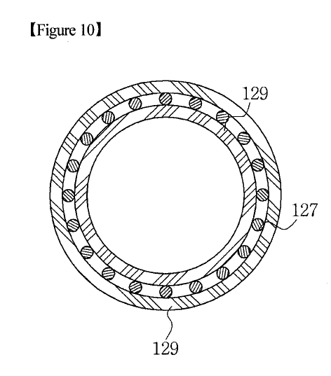

Meanwhile, description will now be made of another embodiment of the invention with reference to FIGS. 8 to 10.

A reference numeral 110 denotes a main body of a wind power generator, which is installed on a post 133.

Front and rear blades 112 and 115 are axially connected to the front and rear of the main body 110 so as to rotate in the wind in such a way as to rotate in opposite directions to each other against the same wind direction.

The rear blade 115 is sufficiently longer than the front blade 112 to receive more of the wind.

A front shaft 116 of the front blade 112 and a rear shaft 113 of the rear blade 115 are coupled to the inside of the main body 110 by means of a bearing. In the middle of the inside of the main body 110, an inner rotating case 118 is coupled by means of a bearing so as to rotate in dependency with the main body. A coil 119 is wound around an inner periphery of the inner rotating case 118.

The front shaft 116 is axially installed in a parallel position in the center of the inner rotating case 118, and magnets 122 are attached to the front shaft 116 in correspondence with the coil 119.

A connector 120 is connected to one end of the inner rotating case 118, and in turn is connected with the rear shaft 113, so that rotating power output from the rear shaft 113 is transmitted to the inner rotating case 118 via the connector 120 so as to rotate the coil at a high speed in one direction.

As the coil 119 and the magnets 122 rotate in opposite directions to each other by the opposite rotating forces of the rear and front blades 115 and 112, the number of intersections between the coil 119 and the magnets 122 increases so as to increase the amount of electricity induced in the coil 119 to about 1.5 to 2 times that induced by a single rotating blade of the prior art.

Further, a recess 120a is formed in an end of the connector 120, and the front shaft 116 is axially connected at its one end and middle portion to the recess 120a by means of a bearing 121a and a vertical plate 125, respectively, which will be described later, so that the front shaft 116 can rotate at a high speed.

Further, an armature 123 is provided on an inner end of the coil 119 so as to discharge electricity, and a brush 124 is provided in abutment with the armature to the vertical plate 125, which is vertically installed near one end side of the main body 110, so as to be supplied with electricity. Thus, electricity can be discharged to the exterior via the brush 124.

Meanwhile, the present invention includes a rotating device for rotating a main body of a large wind power generator in correspondence with the wind direction.

As illustrated in the figure, the rotating device is provided such that a rotating support 126 protrudes to a certain length from the under surface of the main body 110, the rotating support 126 and the post 133 are coupled with each other by means of a bearing 127 so as to allow the rotating support 126 to rotate on the post 133, an upper magnet 128 and a lower magnet 129 are placed between the rotating support 126 and the post 133 in such a way that both the magnets 128 and 129 are positioned to face the same magnetic pole, and tail blades 111 are vertically installed on the upper and lower portions of the main body 110.

With the installation such that the upper and lower magnets 128 and 129 are installed between the post 133 and the rotating support 126 while facing the same magnetic pole, the rotating support 126 and the main body 110 are supported by a repulsive force acting between the upper and lower magnets 128 and 129, so that a load is not concentrated on the bearing 127 thereby facilitating rotating the main body 110 of the generator. Further, with the vertical installation of the tail blades 111 on the upper and lower portions of the main body 110, if the wind direction shifts, a rotating force is transmitted via the tail blades 111 so that the main body 110 of the generator rotates step by step to face the wind.

Meanwhile, an engaging projection 130 protrudes from an outer periphery of the post 133, and a hook 131 protrudes downwards to a certain length from a lower outer periphery of the rotating support 126 so as to engage the engaging projection 130, so that the post and the rotating support are engaged together. Here, since the engaging projection 130 and the hook 131 are separated by a certain distance, the main body attached to the rotating support is prevented from being elevated too highly by the repulsive force between the upper and lower magnets 128 and 129.

The operation and the effects of the above embodiment of the invention will be described as follows.

The front and rear blades 112 and 115 rotate in the wind in directions opposite to each other so as to allow the coil 119 and the magnets 122 in the main body 110 to also rotate in opposite directions to each other, thereby increasing the efficiency of power generation.

Further, the front and rear blades 12 and 115 are provided on opposite sides of the main body 110 so that the center of gravity is not deflected to one side, which makes it possible to prevent the occurrence of uneven wear in the parts of the main body of the generator, thereby increasing the lifetime of a product.

Furthermore, with a uniform distribution of the load of the main body 110 applied to the bearing 127 using the repulsive force between the upper and lower magnets 128 and 129, the main body 110 can freely rotate to face the wind.

The present invention is advantageously applicable to the art of a wind power generator in that the wind power generator operates to instantaneously take a position facing the wind to thereby improve the efficiency of power generation and also prevent the blades from breaking under the strong wind.

1. A wind power generator comprising front and rear blades, which are axially connected to respective front and rear ends of a main body, which is installed on a tower post having a predetermined height, so that the front and rear blades are driven by wind to rotate in directions opposite to each other, a plurality of permanent magnets rotating using a rotating force transmitted from the front blade, and a coil body rotating in a direction opposite to the permanent magnets using a rotating force transmitted from the rear blade, the permanent magnets and the coil body being installed in the main body,
wherein the front blade is connected to a front hub, which is coupled to a leading end of a front shaft axially connected to the front of the main body, a spider is fastened to the middle of the front shaft, and the permanent magnets are installed on an outer diameter of the spider at predetermined intervals, and
wherein a rotating body is coupled at its inner side with the front shaft by means of a bearing so that it receives the permanent magnets, the coil body is installed on the outer side of the rotating body opposite the permanent magnets, and the rear blade is connected to a rear hub coupled to an end of a rear shaft, which is installed to an inner rear end of the main body such that it is connected to an end of the inner side of the rotating body with its end exposed out of a rear end of the main body.

2. The wind power generator according to claim 1, wherein the rear shaft comprises a first rear shaft section connected to the end of the inner side of the rotating body, and a second rear shaft section connected with the first rear shaft section by means of a chain coupling and the rear hub is coupled to the end of the second rear shaft section.

3. The wind power generator according to claim 1, further comprising a rotating device provided in a housing so as to rotate the main body, the housing being vertically provided between the main body and the tower post installed on the ground,
the rotating device comprising a first rotating support-axis which is axially installed as free-rotating means of the main body, a slip ring-fixing axis connected to a lower portion of the first rotating support-axis by means of a coupling, first and second slip rings axially connected to the slip ring-fixing axis as power supply means, a second rotating support-axis functioning as transmitting means of a forced rotating driving force, an electronic clutch axially connected between the slip ring-fixing axis and the second rotating support-axis as transmitting and controlling means of the forced rotating driving force, a worm and a worm gear axially installed on the second rotating support-axis, and a reduction motor axially installed on the worm gear.

4. The wind power generator according to claim 3, further comprising control means for automatically yawing the wind power generator according to a wind direction and a wind speed, the control means comprising:
an encoder for outputting information on wind direction corresponding to a rotated angle of a wind indicator which is installed on the main body; and
a controller for driving the reduction motor in a forward or backward direction according to information on wind direction supplied from the encoder, so as to control the main body to face the wind on a slant.

5. The wind power generator according to claim 4, wherein the control means further comprises a wind gauge detecting and outputting a wind speed using a rotating speed of a wind speed-detecting vane which is installed on the main body, wherein the controller selectively supplies an electric current to the electronic clutch according to the wind speed detected by the wind gauge.

6. The wind power generator according to claim 4, wherein when the detected wind speed corresponds to a first predetermined reference wind speed or less, the controller cuts off an electric current supplied to the electronic clutch so that the main body freely rotates according to the wind direction.

7. The wind power generator according to claim 4, wherein when the detected wind speed is in a range between the first predetermined reference wind speed and a second predetermined reference wind speed, the controller supplies an electric current to the electronic clutch so as to connect the first and second rotating support-axes with each other, and then drives the reduction motor in a forward or backward direction according to information on the wind direction from the encoder, so as to forcibly rotate the main body according to the wind direction.

8. The wind power generator according to claim 4, wherein when the detected wind speed corresponds to a predetermined reference wind speed or more, the controller supplies an electric current to the electronic clutch so as to connect the first and second rotating support-axes with each other, and then drives the reduction motor in a forward or backward direction so as to forcibly rotate the main body perpendicular to the wind direction so that the front and rear blades are not driven.

9. A wind power generator comprising front and rear blades, which are axially connected to front and rear ends, respectively, of a main body, which is installed on a tower post having a predetermined height, so that the front and rear blades are driven by wind to rotate in opposite directions to each other, a plurality of permanent magnets rotating using a rotating force transmitted from the front blade, and a coil body rotating in an opposite direction to the permanent magnets using a rotating force transmitted from the rear blade, the permanent magnets and the coil body being installed in the main body ROM,
wherein a housing is vertically provided between the main body and the tower post installed on the ground, and has therein a rotating device for rotating the main body,
the rotating device including a first rotating support-axis, which is axially installed as free-rotating means of the main body, a slip ring-fixing axis connected to a lower portion of the first rotating support-axis by means of a coupling, first and second slip rings axially connected to the slip ring-fixing axis as power supply means, a second rotating support-axis functioning as transmitting means of a forced rotating driving force, an electronic clutch axially connected between the slip ring-fixing axis and the second rotating support-axis functioning as transmitting and controlling means of the forced rotating driving force, a worm and a worm gear axially installed on the second rotating support-axis, and a reduction motor axially installed on the worm gear,
the wind power generator further comprising control means for automatically yawing the wind power generator according to a wind direction and a wind speed, the control means comprising:
an encoder outputting information on wind direction corresponding to a rotated angle of a wind indicator which is installed on the main body; and
a controller driving the reduction motor in a forward or backward direction according to information on wind direction supplied from the encoder, so as to control the main body to face the wind.

10. The wind power generator according to claim 9, wherein the control means further comprises a wind gauge detecting and outputting a wind speed using a rotating speed of a wind speed-detecting vane which is installed on the main body, wherein the controller selectively supplies an electric current to the electronic clutch according to the wind speed detected by the wind gauge.

11. The wind power generator according to claim 10, wherein when the detected wind speed corresponds to a first predetermined reference wind speed or less, the controller cuts off an electric current supplied to the electronic clutch so that the main body freely rotates according to the wind direction,
wherein when the detected wind speed is in a range between the first predetermined referenced wind speed and a second predetermined reference wind speed, the controller supplies an electric current to the electronic clutch so as to connect the first and second rotating support-axes with each other, and then drives the reduction motor in a forward or backward direction according to information on the wind direction from the encoder, so as to forcibly rotate the main body according to the wind direction, and
wherein when the detected wind speed corresponds to the second predetermined reference wind speed or more, the controller supplies an electric current to the electronic clutch so as to connect the first and second rotating support-axes with each other, and then drives the reduction motor in a forward or backward direction so as to forcibly rotate the main body perpendicular to the wind direction so that the front and rear blades are not driven.

12. A wind power generator comprising a main body rotatably coupled onto a post vertically installed on the ground, the wind power generator further comprising:
front and rear blades, which are installed on front and rear portions, respectively, of the main body so as to rotate in opposite directions to each other against the same wind direction, an inner rotating case installed in the main body and having therein a coil wound around an inner face thereof and a front shaft having magnets at the center thereof such that the coil and the magnets rotate independently of each other, so that opposite power of the front and rear blades is independently transmitted to the inner rotating case and the front shaft, respectively.

13. The wind power generator according to claim 12, further comprising a rotating support protruding to a predetermined length from an under surface of the main body, wherein the rotating support and the post are coupled with each other by means of a bearing so as to allow the rotating support to rotate on the post, an upper magnet and a lower magnet are placed between the rotating support and the post in such a way that both the magnets and are positioned to face the same magnetic pole, and wherein a tail blade is vertically installed on an upper portion of the main body.

14. The large wind power generator according to claim 13, further comprising an engaging projection protruding from an outer periphery of the post and a hook protruding downwards to a predetermined length from a lower outer periphery of the rotating support so as to engage the engaging projection, so that the post and the rotating support are engaged together, the engaging projection and the hook being separated by a predetermined distance.

15. The wind power generator according to claim 6, wherein the first predetermined reference wind speed is about 12 m/s.

16. The wind power generator according to claim 7, wherein the first predetermined reference wind speed is about 12 m/s and the second predetermined reference wind speed is about 18 m/s.

17. The wind power generator according to claim 8, wherein the predetermined reference wind speed is about 18 m/s.

18. The wind power generator according to claim 11, wherein the first predetermined wind speed is about 12 m/s and the second predetermined wind speed is about 18 m/s.
